(19) United States
(12) Patent Application Publication
(10) Pub. No.: US 2017/0004585 A1
(43) Pub. Date: Jan. 5, 2017

(54) METHOD AND SYSTEM FOR PERSONALIZING AND FACILITATING A TAX RETURN PREPARATION INTERVIEW IN A TAX RETURN PREPARATION SYSTEM BY USING A MULTI-SECTIONAL VIEW OF INTERVIEW CONTENT TO PROGRESS A USER THROUGH THE TAX RETURN PREPARATION INTERVIEW

(71) Applicant: Intuit Inc., Mountain View, CA (US)

(72) Inventors: Thai Dang, San Diego, CA (US); Corey Daniel Leamon, Escondido, CA (US); Carol Ann Howe, San Diego, CA (US); Hugh D. Macdonald, San Diego, CA (US); Andrew Roe, Oceanside, CA (US); Alexandra Graham Kopjak, San Diego, CA (US); Lyle Avery Takacs, San Clemente, CA (US); Robert E. Bamford, San Diego, CA (US); Sylvia Knust, La Mesa, CA (US); Alexis Hartford, San Diego, CA (US)

(73) Assignee: Intuit Inc., Mountain View, CA (US)

(21) Appl. No.: 14/788,261

(22) Filed: Jun. 30, 2015

(51) Int. Cl. G06Q 40/00

(52) U.S. Cl. CPC G06Q 40/123

(57) ABSTRACT

A method and system personalizes and facilitates an electronic tax return preparation interview in a tax return preparation system, using a multi-sectional view of interview content, according to one embodiment. The method and system displays first user income information at least partially based on user data, and displays characteristics for the first user income information in a first section of a user interface to indicate to the user which of the first user income information has been identified by an electronic tax return preparation system, according to one embodiment. The method and system, in a second section of the user interface, acquires second user income information from the user, and updates the first section of the user interface with the second user income information acquired from the user within the second section of the user interface.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, many potential customers quit their tax return preparation because traditional tax return preparation systems feel impersonal, or present interview questions in a confusing manner.

For instance, traditional tax return preparation systems often present a fixed, e.g., predetermined and pre-packaged, structure or sequence of questions to all users as part of the tax return preparation interview process. This can be due to the fact that it is easier to hard-code a program to step through a sequence of questions than it is to code a program to interactively determine relevant and non-relevant questions for a user. Additionally, the tax return preparation interview can be perceived as taking a long time because navigation through the interview is difficult or because the interview information is presented in an unclear manner.

Due to negative user experiences that take place during the tax return preparation interview process, traditional tax return preparation systems simply fail to convert a significant portion of potential customers to paying customers. In other words, irrelevant, and often confusing, interview questions are frequently presented to users so that many users, if not all users, of these traditional tax return preparation systems experience, at best, an impersonal, unnecessarily long, confusing, and complicated, interview process and user experience. Clearly, this is not the type of experience that results in satisfied, loyal, and repeat customers.

Even worse is the fact that, in many cases, the hard-coded and static analysis features associated with traditional tax return preparation systems, and the resulting presentation of irrelevant questioning and user experiences, leads potential users of traditional tax return preparation systems, i.e., potential customers, to believe that the tax return preparation system is not applicable to them, and perhaps is unable to meet their specific needs. In other cases, the users simply become frustrated with the seemingly irrelevant lines of questioning. Many of these potential users and customers then simply abandon the tax return preparation interview and the tax return preparation systems completely, i.e., never become paying customers. Clearly, this is an undesirable result for both the potential user of the tax return preparation system and for the provider of the tax return preparation system.

What is needed is a method and system for personalizing and facilitating a tax return preparation interview in a tax return preparation system by using a multi-sectional view of interview content to progress a user through the tax return preparation interview.

### SUMMARY

Embodiments of the present disclosure address some of the shortcomings associated with traditional tax return preparation systems by personalizing and facilitating (e.g., making easier) an electronic tax return preparation interview, by using a multi-sectional view of interview content to progress a user through the interview process, according to one embodiment. A method of operation of the disclosed tax return preparation system reduces a likelihood of abandonment of an electronic tax return preparation interview in a tax return preparation system, by using a multi-sectional view of interview content to progress a user through a tax return preparation interview. By reducing the likelihood of abandonment of the interview by the user, the system generates additional revenue for the service provider, saves users time, and reduces excess computing cycles and network bandwidth associated with longer and less efficient (i.e., traditional) tax return preparation systems.

The disclosed tax return preparation system uses a multi-sectional view of interview content to progress a user through the tax return preparation interview. The tax return preparation system displays initial user income information, such as “W-2 income” from a particular employer. The user income information is at least partially based on user data received from a user. The user data can include an indication that the user was employed by a particular company in the previous year. The tax return preparation system displays characteristics for the user income information, such as employer name, amount of income, and year that the income was earned, according to one embodiment. In a second section of the user interface, the tax return preparation system acquires additional user income information from the user, in response to receipt of an indication from the user that the initial user income information is an incomplete representation of total user income information for the user. The tax return preparation system updates the first section of the user interface with the additional user income information acquired from the user within the second section of the user interface, to provide an updated status of the total user income information acquired by the electronic tax return preparation system for the user, to improve understandability by the user of the tax return preparation interview and to reduce a likelihood of abandonment of the tax return preparation interview by the user.

Embodiments of the present disclosure address some of the shortcomings associated with traditional tax return preparation systems by using multi-sectional views of interview content to progress a user through a tax return preparation interview. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by personalizing and facilitating the tax return preparation interview, a tax return preparation application may be able to gather more complete information from the user and may be able to provide a more thorough and customized analysis of potential tax return benefits for the user, according to one embodiment.

### BRIEF DESCRIPTION OF THE DRAWINGS

FIG. 1 is a block diagram of a software architecture for personalizing and facilitating electronic tax return preparation interviews, in accordance with one embodiment.

FIG. 2 is a flow diagram of a process for personalizing and facilitating electronic tax return preparation interviews, in accordance with one embodiment.

FIG. 3 is a flow diagram for personalizing and facilitating electronic tax return preparation interviews, in accordance with one embodiment.

FIG. 4A is a block diagram of a user interface for guiding a user through a tax return preparation interview, in accordance with one embodiment.

FIG. 4B is a block diagram of a user interface for enabling a self-explored progression through a tax return preparation interview, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, PROCESS, and USER EXPERIENCE sections herein describe systems and processes suitable for personalizing and facilitating electronic tax return preparation interviews by using multi-sectional views of interview content, to progress a user through a personalized tax return preparation interview, and to reduce a likelihood of abandonment of the tax return preparation interview by the user, according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system, e.g., a user computing environment.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “user experience” includes not only the interview process, interview process questioning, and interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

### Hardware Architecture

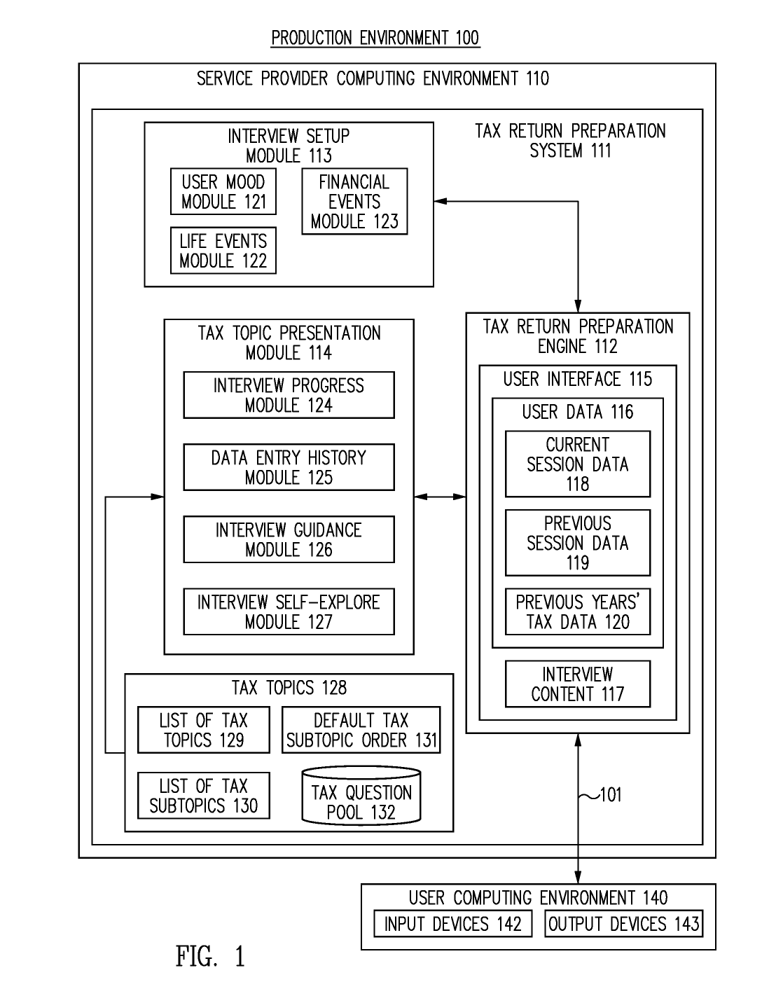

FIG. 1 illustrates a block diagram of a production environment 100 that includes a tax return preparation system for personalizing and facilitating (e.g., making easier) an electronic tax return preparation interview, by using a multi-sectional view of interview content to progress a user through the interview process, according to one embodiment. A method of operation of the disclosed tax return preparation system reduces a likelihood of abandonment of an electronic tax return preparation interview in a tax return preparation system, by using a multi-sectional view of interview content to progress a user through an electronic tax return preparation interview, according to one embodiment. By reducing the likelihood of abandonment of the interview by the user, the system generates additional revenue for the service provider, saves users time, and reduces excess computing cycles and network bandwidth associated with longer and less efficient (i.e., traditional) tax return preparation systems, according to one embodiment.

The disclosed tax return preparation system uses a multi-sectional view of interview content to progress a user through the tax return preparation interview, according to one embodiment. The tax return preparation system displays initial user income information, such as “W-2 income” from a particular employer, according to one embodiment. The user income information is at least partially based on user data received from a user, and the user data can include an indication that the user was employed by a particular company in the previous year, according to one embodiment. The tax return preparation system displays characteristics for the initial user income information, such as employer name, amount of income, and year that the income was earned, according to one embodiment. In a second section of the user interface, the tax return preparation system acquires additional user income information from the user, in response to receipt of an indication from the user that the initial user income information is an incomplete representation of total user income information for the user. The tax return preparation system updates the first section of the user interface with the additional user income information acquired from the user within the second section of the user interface, to provide an updated status of the total user income information acquired by the electronic tax return preparation system for the user, to improve understandability by the user of the tax return preparation interview and to reduce a likelihood of abandonment of the tax return preparation interview by the user.

Embodiments of the present disclosure address some of the shortcomings associated with traditional tax return preparation systems by using multi-sectional views of interview content to progress a user through a tax return preparation interview. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by personalizing and facilitating the tax return preparation interview, a tax return preparation application may be able to gather more complete information from the user and may be able to provide a more thorough and customized analysis of potential tax return benefits for the user, according to one embodiment.

The production environment 100 includes a service provider computing environment 110 and a user computing environment 140 for personalizing and facilitating an electronic tax return preparation interview, according to one embodiment. The computing environments 110 and 140 are communicatively coupled to each other with a communication channel 101, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, e.g., tax filers and/or system administrators, according to one embodiment. The service provider computing environment 110 can be hosted using a number of virtual assets within a virtual asset computing environment (e.g., a cloud computing environment), can be hosted in a traditional data center, or can be executed from the user computing environment 140 (e.g., a desktop computing system), according to various embodiments.

The service provider computing environment 110 includes a tax return preparation system 111 that is configured to personalize and facilitate a tax return preparation interview, according to one embodiment. The tax return preparation system 111 includes various components, databases, engines, modules, and/or data to support progressing the user through the tax return preparation interview process, according to various embodiments.

The tax return preparation system 111 includes a tax return preparation engine 112, an interview setup module 113, and a tax topic presentation module 114, configured to acclimate the user to the interview process and progress the user through a personalized tax return preparation interview, according to one embodiment.

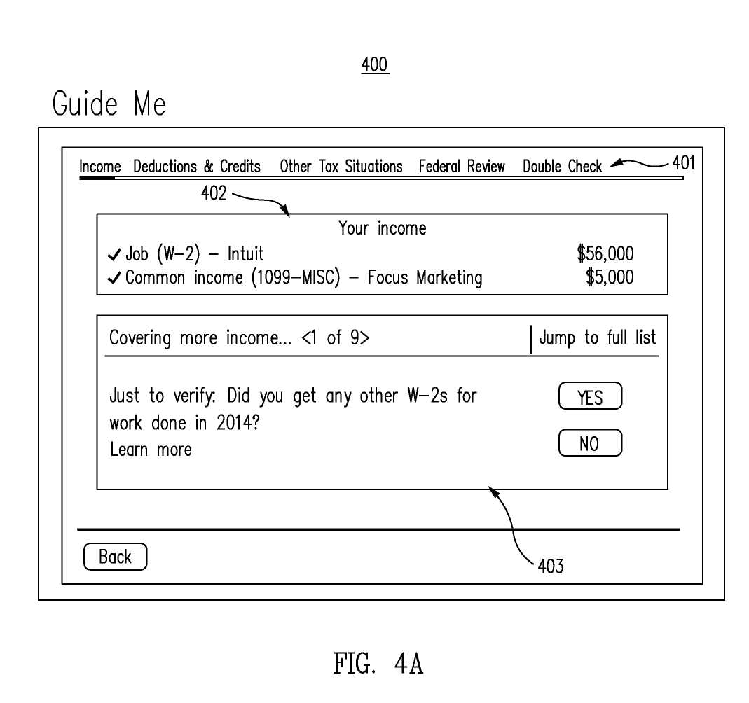

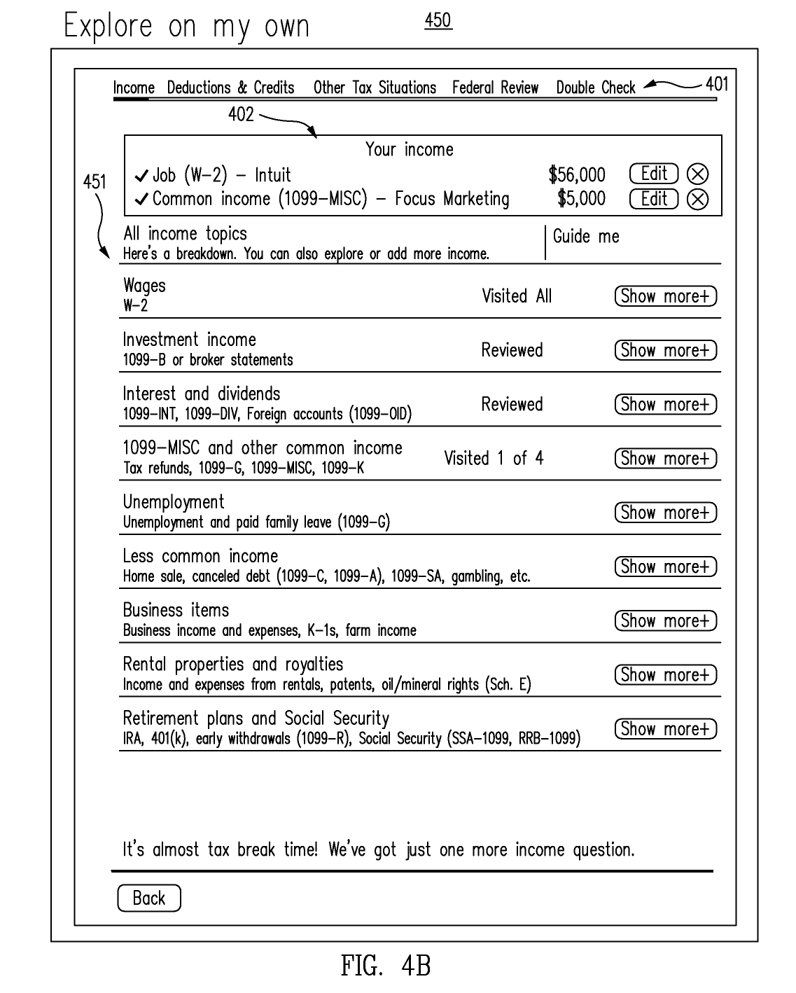

The tax return preparation engine 112 guides the user through the tax return preparation process by presenting the user with a multi-sectional view of interview content, such as a webpage, a series of screens, or a series of dialog boxes that display: interview progress through tax topics, interview questions for particular tax subtopics, icons, interface input tools, text boxes, selection buttons, animations, and other user experience features, according to one embodiment. The tax return preparation engine 112 includes a user interface 115 to receive user data 116 from the user (e.g., from the user computing environment 110) and to present interview content 117 to the user, according to one embodiment. The user interface 115 includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user and for receiving the user data 116 from the user, according to one embodiment. As described in FIGS. 4A and 4B, the user interface 115 can have a first section for displaying income information and/or deduction/credits information for the user and can have a second section to enable the user to provide additional income or deduction/credit information to the user. The tax return preparation engine 112 employs the user interface 115 to receive the user data 116 from input devices 141 (e.g., keyboard, touchscreen, mouse) of the user computing environment 140 and employs the user interface 115 to transmit the customized interview content 117 (inclusive of various user experience elements) to output devices 142 (e.g., monitor, touchscreen, speakers) of the user computing environment 140, according to one embodiment.

The user data 116 includes information collected directly and/or indirectly from the user, according to one embodiment. The user data 116 includes current session data 118, previous session data 119, and previous years' tax data 120, according to one embodiment. The user data 116 includes information, such as, but not limited to, a name, a Social Security number, a government identification, a driver's license number, a date of birth, an address, a zip code, home ownership status, marital status, annual income, W-2 income, a job title, an employer's address, spousal information, children's information, asset information, medical history, occupation, website browsing preferences, a typical lingering duration on a website, information regarding dependents, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, for the electronic preparation of a user's tax return, according to various embodiments. The user data 116 also includes mouse-over information, durations for entering responses to questions, and other clickstream information, according to one embodiment. In some implementations, the user data 116 is a subset of all of the user information used by the tax return preparation system 111 to prepare the user's tax return (e.g., is limited to marital status, children's information, and annual income).

The interview setup module 113 acclimates the user to the tax return preparation interview by attempting to establish a relationship with the user prior to asking difficult questions (e.g., questions that require research to answer), according to one embodiment. The interview setup module 113 provides a lightweight setup that includes visual and interactive questions, according to one embodiment. The interview setup module 113 is configured to simulate a conversation with a person by, for example, providing conversational feedback to simple questions, according to one embodiment. The interview setup module 113 acquires mood information from the user, life changes for a tax year, and/or financial changes for the tax year, according to one embodiment. The interview setup module 113 gathers user data 116, while concurrently establishing a relationship with the user. The gathered user data 116 is then used by the tax topic presentation module 114 to personalize the tax return preparation interview, according to one embodiment. The interview setup module 113 includes a life events module 122 and a financial events module 123, according to one embodiment.

The interview setup module 113 uses the life events module 122 to determine life events or other life-related information that may have existed, occurred, or changed for the user within the tax year for which the tax return is being prepared, according to one embodiment. The life events module 122 uses simple questions and/or visually interactive tools to acquire life events information from the user without causing the user to do research (e.g., refer to paperwork to answer the question), according to one embodiment. In other words, the life events module 122 limits its user queries to questions that can be answered based on the life experiences of the user, according to one embodiment. The life events module 122 presents questions to receive user data, such as, but not limited to, user's age, number of children, marital status, address, and the like, according to one embodiment. The life events module 122 receives life events information from the user by displaying one or more selectable icons (e.g., tiles, bubbles, etc.) that represent a life event or life status for the user, according to one embodiment. The life events module 122 receives life events information from the user with text boxes and drop-down menus, according to another embodiment. The life events module 122 filters the questions and/or the selectable icons presented to the user, based on existing information for the user, which may have been acquired from a previous session or a previous tax year, according to one embodiment.

To convey a perception of thoroughness, the life events module 122 provides one or more messages to the user, in response to a selection of a life event by the user, according to one embodiment. For example, the life events module 122 displays a message such as, “we'll gather all the dependents details needed for your taxes,” in response to the user indicating that the user has children, according to one embodiment.

The interview setup module 113 uses the financial events module 123 to determine financial events or other financial information that may have existed, occurred, or changed for the user within the tax year for which the tax return is being prepared, according to one embodiment. The financial events module 123 uses simple questions and/or visually interactive tools to acquire financial events information from the user without causing the user to do research (e.g., refer to paperwork to answer the question), according to one embodiment. The financial events module 123 presents questions to receive user data, such as, but not limited to, job changes, salary changes, dependent changes, relocation, home ownership status change, employment status change, student status change, or the like, according to one embodiment. The financial events module 123 receives financial events information from the user by displaying one or more selectable icons (e.g., tiles, bubbles, etc.) that represent a financial event or other financial information of the user, according to one embodiment. The financial events module 123 receives financial events information from the user with text boxes and drop-down menus, according to another embodiment. The financial events module 123 filters the questions and/or the selectable icons presented to the user, based on existing information for the user, which may have been acquired from a previous session or previous tax year, according to one embodiment.

To convey a perception of thoroughness, the financial events module 123 provides one or more messages to the user, in response to a selection of a financial event by the user, according to one embodiment. For example, the financial events module 123 displays a message such as, “we'll gather all the home sale details needed for your taxes,” in response to the user indicating that the user has sold a home during the relevant tax year, according to one embodiment.

The tax topic presentation module 114 personalizes the tax subtopics presented to the user to reduce the presentation of irrelevant questions, to reduce frustration and confusion felt by the user, and to make the interview process easier for the user, according to one embodiment. The tax topic presentation module 114 guides the user through a list of tax topics and a list of tax subtopics to progress the user through the tax return preparation interview, according to one embodiment. The tax topic presentation module 114 presents simplified questions (e.g., Boolean questions), for each tax subtopic presented to the user to determine if the tax subtopic is relevant, according to one embodiment. If the subtopic is irrelevant to the user, the tax topic presentation module 114 proceeds to a subsequent tax subtopic in the list of tax subtopics, according to one embodiment. If the subtopic is relevant to the user, the tax topic presentation module 114 presents additional questions related to that particular tax subtopic, according to one embodiment. Accordingly, the tax topic presentation module 114 is configured to progress the user through the tax return preparation interview by presenting easier questions before more difficult questions, to reduce irrelevant questions provided to the user, to reduce frustration and confusion felt by the user, and to make the interview process easier and faster for the user, according to one embodiment. For more experienced users, the tax topic presentation module 114 is configured to display a list of tax subtopics, for each tax topic, to allow the user to self-explore the relevant tax subtopics and the tax questions associated with the relevant tax subtopics, according to one embodiment.

The tax topic presentation module 114 includes an interview progress module 124, a data entry history module 125, an interview guidance module 126, and an interview self-explore module 127, for progressing a user through the tax return preparation interview, according to one embodiment.

The tax topic presentation module 114 uses the interview progress module 124 to provide a map, directory, progress status, and/or navigational tool, for the benefit of the user during the tax return preparation interview, according to one embodiment. The tax topic presentation module 114 tracks the user's progress through the interview, and updates a status of the user's location within the interview, with a progress menu, according to one embodiment.

The progress menu includes a list of the tax topics 129 that are included in the tax return preparation interview, according to one embodiment. The list of tax topics 129 is based on tax topics 128 that are stored by the tax return preparation system 111, according to one embodiment. The list of tax topics 129 includes, but is not limited to, Wages & Income, Deductions & Credits, and Other Tax Situations, according to one embodiment. The progress menu can also include items such as a section review (e.g., Federal Taxes Review) and a double-check section, to assist the user in navigating through the interview process, according to one embodiment. The interview progress module 124 highlights (e.g., underlines) the menu item that is associated with the current section (e.g., Deductions & Credits) that the user is working on, according to one embodiment. The interview progress module 124 enables the user to navigate between different sections of the interview process by clicking or otherwise selecting one of the words, buttons, or links of the progress menu, according to one embodiment. The interview progress module 124 positions the progress menu on the top, side, or bottom of the webpage, screen, or other user interface tool, to make the progress menu easy to locate and recognize during the tax return preparation interview, according to one embodiment.

The tax topic presentation module 114 uses the data entry history module 125 to display a history of tax subtopics or other contents that have been completed by the user within the tax topics or that have been imported by the tax return preparation system 111 based on user data 116 received from the user, according to one embodiment. In one embodiment, the data entry history module 125 displays information about one or more W-2s or contractor income earned by the user in one or more previous tax years. In one embodiment, the tax return preparation system 111 uses some user data 116 to retrieve W-2 or other income information from payroll systems, and displays the retrieved information for viewing and/or verification by the user. The display of the data entry history allows the user to assess what the user has done and to determine if the user needs to continue work within a particular section or tax subtopic, according to one embodiment. The display of the data entry history has a function that is similar to a shopping cart of subtopics the user has selected and entered information for, according to one embodiment. The data entry history module 125 updates the data entry history dynamically, as the user enters additional data for one or more tax subtopics, so that the user has a real-time display/journal of what the user has accomplished, according to one embodiment. When combined with the progress menu, the data entry history assists the user in understanding how much of the interview is complete and how much of the interview is remaining, to provide a sense of progress and accomplishment, according to one embodiment. The integration of the progress menu and the data entry history reduces the confusion a user might have about what has been accomplished and what remains to be accomplished to complete the tax return preparation interview, according to one embodiment. In one embodiment, the progress menu and the data entry history are compartmentalized, e.g., separated, on a webpage or other user interface to simplify locating navigational and data entry history information for the user, according to one embodiment.

In one embodiment, the tax topic presentation module 114 presents information from the data entry history module 125 in a first section of a user interface and displays information from the interview guidance module or from the interview self-explore module 127 in a second section of the user interface, to reduce a likelihood of abandonment of a tax return preparation interview by a user, according to one embodiment. By providing a multi-sectional view of interview content (e.g., data from the user, data about the user, or information/questions from the tax return preparation system), the tax return preparation system 111 can orient a user within the tax return preparation interview and reduce a likelihood of confusion and frustration by persistently providing the user with an updated status of income and/or deductions that appear to be relevant to the user, according to one embodiment.

The tax topic presentation module 114 uses the interview guidance module 126 to progressively step the user through each tax subtopic of each tax topic of a tax return preparation interview, according to one embodiment. The interview guidance module 126 personalizes the presentation of the list of tax subtopics 130 to the user by presenting easier questions before more difficult questions, for each of the tax subtopics of the list of tax subtopics 130, according to one embodiment. For example, the interview guidance module 126 provides the user with a Boolean question (e.g., a question to which the response is “yes” or “no”) to determine whether a particular subtopic is relevant to the user, according to one embodiment. If the subtopic is relevant to the user, the interview guidance module 126 provides one or more additional questions with which to gather user data 116 that is related to the particular tax subtopic, according to one embodiment. Accordingly, a user is less likely to be confused, frustrated, or be forced to waste the time considering the detailed questions about a particular tax subtopic, when that particular tax subtopic is unrelated to the user, according to one embodiment.

The list of tax subtopics 130 is different for each of the tax topics 128, according to one embodiment. For example, one tax topic 128 is Income, according to one embodiment. The list of tax subtopics 130 for the tax topic Income includes, but is not limited to, wages, investment income, interest and dividends, 1099-MISC and other common income, unemployment, less common income, business items, rental properties and royalties, retirement plans and Social Security, according to one embodiment. Each tax subtopic within the list of tax subtopics 130 includes, but is not limited to, one or more subsections such as W-2, 1099-B, broker statements, 1099-INT, 1099-DIV, foreign accounts (1099-OID), tax refunds, 1099-G, 1099-K, paid family leave, home still, canceled debt (1099-C, 1099-A), gambling, farm income, oil/mineral rights, individual retirement accounts, 401(K), and the like, according to one embodiment. As another example, another tax topic 128 is Deductions & Credits, according to one embodiment. The list of tax subtopics 134 for the tax topic Deductions & Credits includes, but is not limited to, your home, you and your family, charitable donations, cars and other things you own, education, medical, estimates and other taxes paid, retirement and investments, employment expenses, other deductions and credits, according to one embodiment. The subsections within the list of tax subtopics 130 include, but are not limited to, one or more subsections such as property taxes, mortgage interest, home refinance, energy improvements, child care, earned income credit, adoption credit, clothes and other items, money, miles driven, stock, registration fees, alternative motor vehicles, scholarships, student loans, tuition, health savings account, prescriptions, medical bills, estimated taxes, sales tax for items like cars, individual retirement accounts, investment interest expenses, teacher expenses, other job-related expenses, tax preparation fees, moving expenses, theft, alimony, and the like, according to one embodiment.

In one embodiment, the interview guidance module 126 sorts the list of tax subtopics 130, by relevance to the user, and presents the more-relevant tax subtopics to the user before presenting the less-relevant tax subtopics to the user, according to one embodiment. According to one embodiment, the presentation of tax subtopics is synonymous with presenting one or more tax questions that are associated with a particular tax subtopic. The interview guidance module 126 uses a default tax subtopics order 131 to deliver tax questions from a tax question pool 132, according to one embodiment. The interview guidance module 126 is configured to prioritize the list of tax subtopics 130, and deliver tax questions from the tax question pool 132, based on the user data 116 that is acquired from the user with the interview setup module 113, according to one embodiment. In other embodiments, the interview guidance module 126 prioritizes the list of tax subtopics 130 based on user data 116 acquired any time during the tax return preparation interview or acquired in previous years' tax return preparation interviews.

The interview guidance module 126 delivers the tax questions for the list of tax subtopics 130 in a region of a webpage or other user interface that is compartmentalized or separated from regions used by the data entry history module 125 and the interview progress module 124, according to one embodiment. In other words, the tax topic presentation module 114 maintains separate regions in the interview content 117, e.g., webpage, for the progress menu, for the data entry history, and for the tax questions used to progress the user through the tax return preparation interview, according to one embodiment. An example embodiment of the implementation of these different regions is illustrated in FIG. 4A and is described in the USER EXPERIENCE section below. The tax topic presentation module 114 displays the data entry history in an upper region, e.g., top region, of the interview content 117, and displays the tax questions or remaining tasks in a lower region, e.g., a bottom region, of the interview content 117, to provide the user with a perception that the tax return preparation system 111 is thoroughly meeting the needs of the user, according to one embodiment.

In one embodiment, the interview guidance module 126 enables the user to opt out of an auto-guided progression through the interview to allow the user to self-explore the list of tax subtopics 130 and the corresponding tax questions in an order and in a manner of the user's own choosing, according to one embodiment.

The interview self-explore module 127 enables the user to self-explore the list of tax subtopics 130 in an order and in a manner of the user's own choosing, according to one embodiment. The interview self-explore module 127 displays the entire list of tax subtopics 130 for a particular tax topic, according to one embodiment. Each tax subtopic in the list of tax subtopics 130 includes a status, such as, but not limited to, reviewed, completed, partially completed (e.g., 1 of 4 sections completed), and not reviewed, according to one embodiment. The interview self-explore module 127 displays the list of tax subtopics 130 using one or more directory trees or other logical structures to hide or display subsections or questions for each of the tax subtopics in the list of tax subtopics 130, according to one embodiment. The interview self-explore module 127 allows the user to expand one or more of the tax subtopics in the list of tax subtopics 130, so the user may review and/or enter data for particular tax subtopics, subsections of tax subtopics, or for questions related to tax subtopics, according to one embodiment. In one embodiment, the interview self-explore module 127 displays the list of tax subtopics 130 in order of relevance to the user, with more-relevant tax subtopics being located at the top of the list and with less-relevant tax subtopics being located at the bottom of the list, according to one embodiment. In one embodiment, the interview guidance module 126 and the interview self-explore module 127 uses the same order of relevance or prioritization for delivering or presenting the list of tax subtopics 130.

The interview self-explore module 127 presents the list of tax subtopics 130 in a region of a webpage or other user interface that is compartmentalized or separated from regions used by the data entry history module 125 and the interview progress module 124, according to one embodiment. In other words, the tax topic presentation module 114 maintains separate regions in the interview content 117, e.g., webpage, for the progress menu, for the data entry history, and for displayed list of tax subtopics 130, according to one embodiment. An example embodiment of the implementation of these different regions is illustrated in FIG. 4B and is described in the USER EXPERIENCE section below. The tax topic presentation module 114 displays the data entry history in an upper region, e.g., top region, of the interview content 117, and displays the list of tax subtopics 130 in a lower region, e.g., a bottom region, of the interview content 117, to provide the user with a perception that the tax return preparation system 111 is thoroughly meeting the needs of the user, according to one embodiment.

In one embodiment, the interview self-explore module 127 enables the user to opt out of a self-explore progression through the interview to receive the auto-guided progression through the tax return preparation interview, according to one embodiment.

The interview guidance module 126 and the interview self-explore module 127 are configured to display information to the user in a different part of the user interface than the data entry history module 125, so that a physical separation of information facilitates comprehension for the user of all that has already been accomplished and what parts yet remain to be entered in the tax return preparation interview.

Unlike traditional tax return preparation systems, the tax return preparation system 111 can reduce confusion, frustration, and trust issues of users by acclimating the user to the interview process and by filtering irrelevant questions with easy questions that are not difficult for the user to understand and respond to. As a result, the features and techniques described herein are, in many ways, superior to the service received from a tax return specialist/preparer. For example, human error associated with a tax return specialist is eliminated, the hours of availability of the tax return specialist become irrelevant, the daily number of customers is not limited by the number of people a tax return specialist is able to visit on a daily basis, and the computerized tax return preparation process is unaffected by emotion, tiredness, stress, or other external factors that may be inherent in a tax return specialist during tax return season.

In accordance with an embodiment, the tax return preparation system personalizes and facilitates an electronic tax return preparation interview in a tax return preparation system, by using a multi-sectional view of interview content to progress a user through the electronic tax return preparation interview and to reduce a likelihood of abandonment of the tax return preparation interview that may be caused by confusion or frustration. The tax return preparation system displays first user income information at least partially based on user data received from a user. The first user income information identifies one or more of employee wages, contractor income, retirement income, unemployment income, alimony, and investment income, according to one embodiment. Prior to acquiring second user income information from the user during the tax return preparation interview, the tax return preparation system displays characteristics for the first user income information in a first section of a user interface to orient the user with an income section of a tax return preparation interview and to indicate to the user which of the first user income information has been identified by the tax return preparation system. As used herein, the tax return preparation system is an electronic tax return preparation system, according to one embodiment. In a second section of the user interface, the tax return preparation system receives or acquires second user income information from the user, in response to receipt of an indication from the user that the first user income information is an incomplete representation of total user income information for the user. For example, the user can select from one or more buttons labeled “start”, “additional income”, “additional deductions”, or the like to indicate that the user may have additional income or deductions or personal information to enter into the tax return preparation system. In response, the tax return preparation system provides the user with self-guided table of tax topics or with an automated presentation of tax-related questions to assist the user with preparing his/her tax return with the tax return preparation system.

The tax return preparation system updates the first section of the user interface with the second user income information acquired from the user, within the second section of the user interface, to provide an updated status of the total user income information that has been acquired by the electronic tax return preparation system for the user, to improve understandability by the user of the tax return preparation interview and to reduce a likelihood of abandonment of the tax return preparation interview by the user, according to one embodiment.

In one embodiment, the tax return preparation system acquires the second user income by providing, in the second section of the user interface, the tax return preparation system uses an expandable table of contents of tax topics or a guided question and answer interface to acquire addition information from the user regarding the taxable income or deductions that are relevant to the user.

In one embodiment, the tax topics associated with the taxable income for the user are ranked in order of relevance to the user, at least partially based on the first user income information and at least partially based on the user data. The tax return preparation system provides the guided question and answer interface in an order of relevance to the user (more relevant questions before less relevant questions).

In one embodiment, the characteristics include a source of user income and a quantity of user income. For example, the source of user income can include the employer's name, the name of the user's company (if self-employed), a company name for retirement income, and a retirement account for retirement income, and the quantity of user income can include, for example, $53,000.

In one embodiment, the first section of the user interface is different from the second section, and the first section occupies a different area within the user interface than the second section. For example, the first section of the user interface can be positioned above the second section of the user interface so that the topics and information that have already been entered/acquired is summarized at the top of the user interface, and the tax topics that are being covered (or that will be covered) are at the bottom of the user interface.

In one embodiment, the tax return preparation system displays, with a computing device, first user deduction information at least partially based on user data received from a user. For example, if the first user deduction indicates that the user has 3 children, the tax return preparation system may be configured to indicate child tax credit eligibility and provide 3 additional standard deductions for the three children in the first section of the user interface.

In one embodiment, the first user deduction information identifies one or more of child tax credit, mortgage interest, earned income credit, student load interest, dependent information, and charitable donations for the user.

In one embodiment, prior to acquiring second user deduction information from the user during the tax return preparation interview, the tax return preparation system displays characteristics for the first user deduction information in the first section of the user interface, to orient the user with a deduction section of the tax return preparation interview, and to indicate to the user which of the first user deduction information has been identified by the electronic tax return preparation system as being relevant to the user.

In one embodiment, in the second section of the user interface, the tax return preparation system acquires second user deduction information from the user, in response to receipt of an indication from the user that the first user deduction information is an incomplete representation of total user deduction information for the user. The user indicates that the first user deduction information is incomplete by, for example, selecting a button or menu that allows the user to enter additional deduction information or that enables the user to browse additional tax topics that may be relevant to the user, according to one embodiment.

In one embodiment, the tax return preparation system updates the first section of the user interface with the second user deduction information acquired from the user, within the second section of the user interface, to provide an updated status of the total user deduction information that has been acquired by the electronic tax return preparation system for the user, to improve understandability by the user of the tax return preparation interview and to reduce the likelihood of abandonment of the tax return preparation interview by the user.

In one embodiment, the tax return preparation system acquires the second user deduction by providing, in the second section of the user interface, at least one of: an expandable and self-explorable table of contents of tax topics associated with tax deductions and credits; and a guided question and answer exploration through the tax topics associated with tax deductions and credits.

In one embodiment, the tax topics associated with the tax deductions and credits are ranked in order of relevance to the user, based on the first and second user income information and at least partially based on the user data. The tax return preparation system provides the guided question and answer interface for a number of tax topics by providing questions related with the tax topics associated with the tax deduction and credits in the order of relevance to the user.

### Process

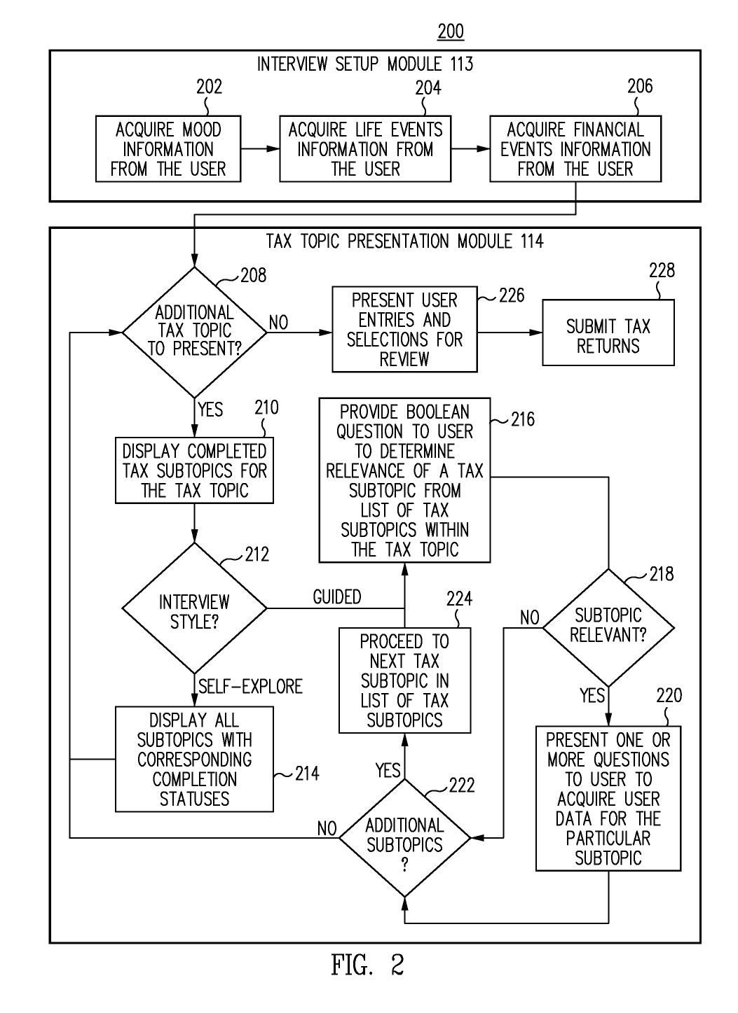

FIG. 2 illustrates a functional flow diagram of a process 200 for personalizing and facilitating tax return preparation interviews by using a multi-sectional view user interface to separate acquired tax information from questions and tables useful for acquiring additional tax information from the user, according to one embodiment.

At block 202, the interview setup module 113 acquires new information (e.g., user data) from the user, according to one embodiment. The interview setup module 113 acquires new information from the user by asking simple mood-related questions or by displaying interactive user elements from which the user may select the user's mood, according to one embodiment.

At block 204, the interview setup module 113 acquires life events information (e.g., user data) from the user, according to one embodiment. The life events information include, but are not limited to, an address of the user, an age of the user, a number of children or dependents for the user, and the like, according to one embodiment. The interview setup module 113 acquires life events information from the user by asking questions that can be answered without doing research, e.g., without having to refer to paperwork to answer the question, according to one embodiment.

At block 206, the interview setup module 113 acquires financial events information (e.g., user data) from the user, according to one embodiment. The financial events information include, but are not limited to, a change of job, a change in salary, an additional dependent, a change in employment status, the sale of a house, a purchase of a house, becoming a business owner, receiving independent contractor income, and the like, according to one embodiment. The interview setup module 113 acquires financial events information from the user by asking questions that can be answered without research, according to one embodiment.

At block 208, the tax topic presentation module 114 determines if additional tax topics are to be presented to the user, according to one embodiment. Tax topics can include, but are not limited to, income, deductions & credits, and other tax situations, according to one embodiment. If the tax topic presentation module 114 determines that additional tax topics are available for presentation to the user, the process proceeds to block 210, according to one embodiment. If not, the process proceeds to block 226, according to one embodiment.

At block 210, the tax topic presentation module 114 displays completed subtopics for the tax topic, according to one embodiment. The tax topic presentation module 114 is configured to display completed tax subtopics along with numbers or other data entered for the tax subtopics at the top of a webpage, screen, or other user interface, according to one embodiment.

At block 212, the tax topic presentation module 114 receives an interview style selection from the user, according to one embodiment. If the user selects a self-explore interview style, the process proceeds to block 214, according to one embodiment. If the user selects a guided interview style, the process proceeds to block 216, according to one embodiment.

At block 214, the tax topic presentation module 114 displays all tax subtopics with corresponding completion statuses, according to one embodiment. The tax topic presentation module 114 displays the tax subtopics in a lower portion (or second section) of the user interface for the tax return preparation system, according to one embodiment. By displaying the tax subtopics, the tax topic presentation module 114 enables the user to explore/navigate through the various tax subtopics to enter user data into tax subtopics that the user deems to be relevant to the user's situation, according to one embodiment. From block 214, the process returns to block 208, according to one embodiment.

At block 216, the tax topic presentation module 114 provides a Boolean question to the user to determine a relevance of a tax subtopic from a list of tax subtopics within a tax topic, according to one embodiment. The tax topic presentation module 114 displays the Boolean question(s) in a lower portion (or second section) of the user interface for the tax return preparation system, according to one embodiment

At block 218, the tax topic presentation module 114 determines if a subtopic is relevant to the user, according to one embodiment. The tax topic presentation module 114 receives an answer to the Boolean question from the user as to whether the subtopic is relevant to the user, according to one embodiment. If the subtopic is relevant to the user, the process proceeds to block 220, according to one embodiment. If the subtopic is irrelevant to the user, the process proceeds to block 222, according to one embodiment.

At block 220, the tax topic presentation module 114 presents one or more questions to the user to acquire user data for the particular subtopic, in a lower portion (or second section) of the user interface, according to one embodiment. The tax topic presentation module 114 can present one or more questions in one or more screens, on one or more webpages, in one or more dialog boxes, or on a single user interface, according to various embodiments.

At block 222, the tax topic presentation module 114 determines if additional subtopics exist within the list of tax subtopics for a tax topic, according to one embodiment. If additional tax subtopics do not exist within the tax topic, the process proceeds to block 208, according to one embodiment. If additional tax subtopics do exist within the tax topic, the process proceeds to block 224, according to one embodiment.

At block 224, the tax topic presentation module 114 proceeds to the next tax subtopic in the list of tax subtopics, according to one embodiment. From block 224, the process proceeds to block 216, according to one embodiment.

At block 226, the tax topic presentation module 114 presents user entries and selections for review, according to one embodiment. The tax topic presentation module 114 presents/displays the user entries and selection to the user in an upper portion (e.g., a first section) of the user interface, so that the user has a updated status of the user's information in a portion of the user interface that is separated from a self-explore or question/answer region of the user interface, according to one embodiment. The process proceeds to block 228, according to one embodiment.

At block 228, the process submits the tax returns, according to one embodiment. The tax return preparation engine can submit a federal tax return and one or more state tax returns for the user, upon completion of the tax return preparation interview. This is the end of the process, in one embodiment.

Although a particular sequence is described herein for the execution of the process 200, other sequences can also be implemented, according to other embodiments. In one embodiment, each time the interview setup module 113 or the tax topic presentation module 114 transmits information to or receives information from the user, the modules do so through the tax return preparation engine 112.

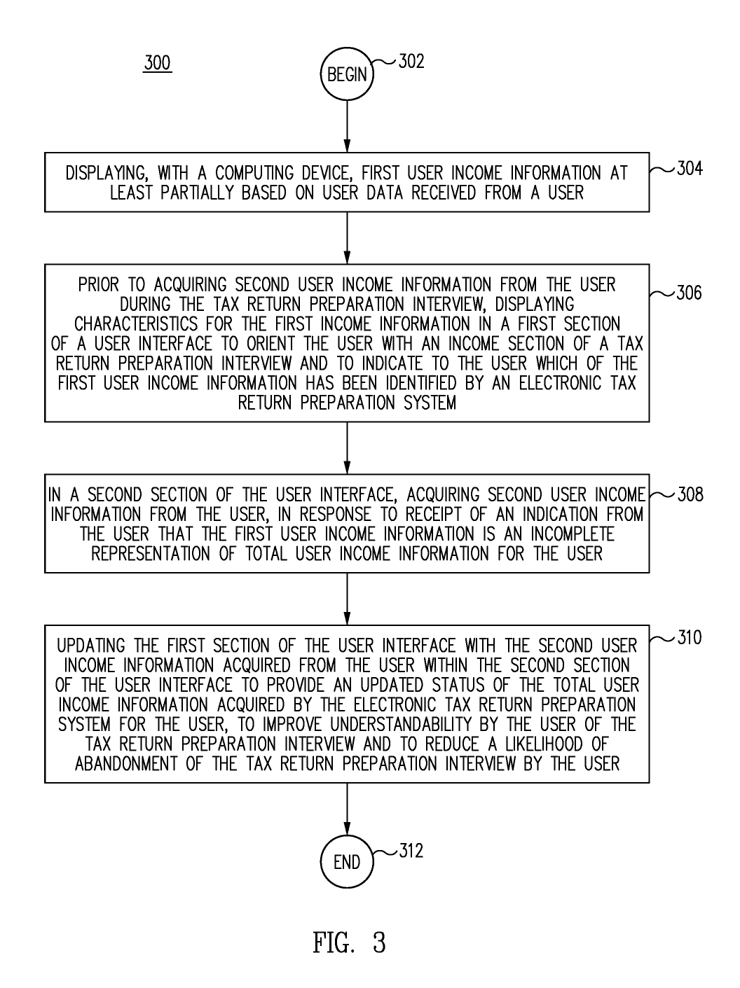

FIG. 3 illustrates a flow diagram of a process 300 for personalizing and facilitating tax return preparation interviews, according to various embodiments.

At block 302, the process begins.

At block 304, the process includes displaying, with a computing device, first user income information at least partially based on user data received from a user, according to one embodiment.

At block 306, prior to acquiring second user income information from the user during the tax return preparation interview, the process includes displaying characteristics for the first user income information in a first section of a user interface to orient the user with an income section of a tax return preparation interview and to indicate to the user which of the first user income information has been identified by an electronic tax return preparation system, according to one embodiment.

At block 308, in a second section of the user interface, the process includes acquiring second user income information from the user, in response to receipt of an indication from the user that the first user income information is an incomplete representation of total user income information for the user, according to one embodiment.

At block 310, the process includes updating the first section of the user interface with the second user income information acquired from the user within the second section of the user interface to provide an updated status of the total user income information acquired by the electronic tax return preparation system for the user, to improve understandability by the user of the tax return preparation interview and to reduce a likelihood of abandonment of the tax return preparation interview by the user, according to one embodiment.

At block 312, the process ends.

Although a particular sequence is described herein for the execution of the process 300, other sequences can also be implemented, according to other embodiments.

### User Experience

FIGS. 4A and 4B illustrate examples of user interfaces that are used by the tax return preparation system 111 to provide an auto-guided or self-explored tax return preparation interview, according to one embodiment.

FIG. 4A illustrates a user interface 400 for providing an auto-guided tax return preparation interview, according to one embodiment. The user interface 400 includes a progress menu region 401, a data entry history region 402, and a tax question region 403, according to one embodiment. Each of the regions are compartmentalized from the other regions for clarity and simplicity, according to one embodiment. The progress menu region 401 indicates which tax topic the user is currently on (e.g., Income), indicates which tax topics or sections of the interview exist, and provides links for navigating between the tax topics or sections of the interview, according to one embodiment. The data entry history region 402 indicates which tax subtopics (e.g., within the tax topic of Income) the user has completed or entered data for, according to one embodiment. The tax question region 403 displays a simplified tax question about a tax subtopic to determine if the tax subtopic is relevant to the user, prior to presenting additional detailed questions about the tax subtopic, according to one embodiment. The data entry history region 402 is a first section in the user interface 400 and the tax question region 403 is a second section in the user interface 400, according to one embodiment.

FIG. 4B illustrates a user interface 450 for providing a self-explored tax return preparation interview, according to one embodiment. The user interface 450 includes a tax subtopic menu region 451, in addition to the progress menu region 401 and the data entry history region 402, according to one embodiment. The data entry history region 402 is a first section in the user interface 400 and the tax subtopic menu region 451 is a second section in the user interface 400, according to one embodiment. The tax subtopic menu region 451 is compartmentalized from the progress menu region 401 and from the data entry history region 402, according to one embodiment. The tax subtopic menu region 451 provides a tax subtopic menu (e.g., a directory tree) from which the user may select, expand, review, enter data into, collapse, and/or skip various tax subtopics, according to one embodiment. The user interface 450 enables the user to go to or return to the auto-guided interview option, according to one embodiment.

As noted above, the specific illustrative examples discussed above are but illustrative examples of implementations of embodiments of the method or process for personalizing and facilitating tax return preparation interviews. Those of skill in the art will readily recognize that other implementations and embodiments are possible. Therefore the discussion above should not be construed as a limitation on the claims provided below.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In accordance with an embodiment, a system personalizes and facilitates an electronic tax return preparation interview in a tax return preparation system, using a multi-sectional view of interview content to progress a user through the tax return preparation interview. The system includes at least one processor, and at least one memory coupled to the at least one processor. The at least one memory storing instructions which, when executed by any set of the one or more processors, perform a process for personalizing and facilitating an electronic tax return preparation interview in a tax return preparation system, using a multi-sectional view of interview content, according to one embodiment. The process includes displaying, with a computing device, first user income information at least partially based on user data received from a user, according to one embodiment. The first user income information identifies one or more of employee wages, contractor income, retirement income, unemployment income, alimony, and investment income, according to one embodiment. Prior to acquiring second user income information from the user during the tax return preparation interview, the process includes displaying characteristics for the first user income information in a first section of a user interface to orient the user with an income section of a tax return preparation interview and to indicate to the user which of the first user income information has been identified by an electronic tax return preparation system, according to one embodiment. In a second section of the user interface, the process includes acquiring second user income information from the user, in response to receipt of an indication from the user that the first user income information is an incomplete representation of total user income information for the user, according to one embodiment. The process includes updating the first section of the user interface with the second user income information acquired from the user within the second section of the user interface to provide an updated status of the total user income information acquired by the electronic tax return preparation system for the user, to improve understandability by the user of the tax return preparation interview and to reduce a likelihood of abandonment of the tax return preparation interview by the user, according to one embodiment.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for personalizing and facilitating an electronic tax return preparation interview in a tax return preparation system, by using a multi-sectional view of interview content to progress a user through the electronic tax return preparation interview, comprising:
displaying, with a computing device, first user income information at least partially based on user data received from a user, wherein the first user income information identifies one or more of employee wages, contractor income, retirement income, unemployment income, alimony, and investment income;
prior to acquiring second user income information from the user during the tax return preparation interview, displaying characteristics for the first user income information in a first section of a user interface to orient the user with an income section of a tax return preparation interview and to indicate to the user which of the first user income information has been identified by an electronic tax return preparation system;
in a second section of the user interface, acquiring second user income information from the user, in response to receipt of an indication from the user that the first user income information is an incomplete representation of total user income information for the user; and
updating the first section of the user interface with the second user income information acquired from the user within the second section of the user interface to provide an updated status of the total user income information acquired by the electronic tax return preparation system for the user, to improve understandability by the user of the tax return preparation interview and to reduce a likelihood of abandonment of the tax return preparation interview by the user.

2. The method of claim 1, wherein acquiring the second user income includes providing, in the second section of the user interface, at least one of:
an expandable table of contents of tax topics associated with taxable income for the user; and
a guided question and answer exploration through the tax topics associated with the taxable income.

3. The method of claim 2, wherein the tax topics associated with the taxable income for the user are ranked in order of relevance to the user, at least partially based on the first user income information and at least partially based on the user data, wherein providing the guided question and answer exploration through tax topics associated with the taxable income includes providing questions related to the tax topics associated with the taxable income, in the order of relevance to the user.

4. The method of claim 1, wherein the characteristics include a source of user income and a quantity of the user income.

5. The method of claim 1, wherein the first section is different from the second section and the first section occupies a different area within the user interface than the second section.

6. The method of claim 5, wherein the first section is positioned above the second section in the user interface.

7. The method of claim 1, further comprising:
displaying, with a computing device, user deduction information at least partially based on user data received from a user.

8. The method of claim 7, wherein the user deduction information identifies one or more of child tax credit, mortgage interest, earned income credit, student load interest, dependent information, and charitable donations for the user.

9. The method of claim 7, wherein the user deduction information is first user deduction information, the method further comprising:
prior to acquiring second user deduction information from the user during the tax return preparation interview, displaying characteristics for the first user deduction information in the first section of the user interface to orient the user with a deduction section of the tax return preparation interview and to indicate to the user which of the first user deduction information has been identified by the electronic tax return preparation system as being relevant to the user.

10. The method of claim 9, further comprising:
in the second section of the user interface, acquiring the second user deduction information from the user, in response to receipt of an indication from the user that the first user deduction information is an incomplete representation of total user deduction information for the user; and
updating the first section of the user interface with the second user deduction information acquired from the user within the second section of the user interface to provide an updated status of the total user deduction information acquired by the electronic tax return preparation system for the user, to improve understandability by the user of the tax return preparation interview and to reduce the likelihood of abandonment of the tax return preparation interview by the user.

11. The method of claim 10, wherein acquiring the second user deduction includes providing, in the second section of the user interface, at least one of:
an expandable and self-explorable table of contents of tax topics associated with tax deductions and credits; and
a guided question and answer exploration through the tax topics associated with tax deductions and credits.

12. The method of claim 11, wherein the tax topics associated with the tax deductions and credits are ranked in order of relevance to the user, based on the first and second user income information and at least partially based on the user data, wherein providing the guided question and answer exploration through tax topics includes providing questions related with the tax topics associated with the tax deduction and credits in the order of relevance to the user.

13. The method of claim 1, wherein the user data includes one or more of:
a change in marital status;
a change in number of dependents;
a change of address; and
a death.

14. The method of claim 1, wherein user data includes one or more of:
a job change;
a change in salary;
a new dependent;
a change of address;
a purchase of a home;
a selling of a home;
receipt of unemployment;
educational expenses;
indication of having performed contract work; and
ownership of a business.

15. A system for personalizing and facilitating an electronic tax return preparation interview in a tax return preparation system, using a multi-sectional view of interview content, the system comprising:
at least one processor; and
at least one memory coupled to the at least one processor, the at least one memory having stored therein instructions which, when executed by any set of the one or more processors, perform a process for personalizing and facilitating an electronic tax return preparation interview in a tax return preparation system, using a multi-sectional view of interview content, the process including:
displaying, with a computing device, first user income information at least partially based on user data received from a user, wherein the first user income information identifies one or more of employee wages, contractor income, retirement income, unemployment income, alimony, and investment income;
prior to acquiring second user income information from the user during the tax return preparation interview, displaying characteristics for the first user income information in a first section of a user interface to orient the user with an income section of a tax return preparation interview and to indicate to the user which of the first user income information has been identified by an electronic tax return preparation system;
in a second section of the user interface, acquiring second user income information from the user, in response to receipt of an indication from the user that the first user income information is an incomplete representation of total user income information for the user; and
updating the first section of the user interface with the second user income information acquired from the user within the second section of the user interface to provide an updated status of the total user income information acquired by the electronic tax return preparation system for the user, to improve understandability by the user of the tax return preparation interview and to reduce a likelihood of abandonment of the tax return preparation interview by the user.

16. The system of claim 15, wherein acquiring the second user income includes providing, in the second section of the user interface, at least one of:
an expandable table of contents of tax topics associated with taxable income for the user; and
a guided question and answer exploration through the tax topics associated with the taxable income.

17. The system of claim 16, wherein the tax topics associated with the taxable income for the user are ranked in order of relevance to the user, at least partially based on the first user income information and at least partially based on the user data, wherein providing the guided question and answer exploration through tax topics associated with the taxable income includes providing questions related to the tax topics associated with the taxable income, in the order of relevance to the user.

18. The system of claim 15, wherein the characteristics include a source of user income and a quantity of the user income.

19. The system of claim 15, wherein the first section is different from the second section and the first section occupies a different area within the user interface than the second section.

20. The system of claim 19, wherein the first section is positioned above the second section in the user interface.

21. The system of claim 15, further comprising:
displaying, with a computing device, user deduction information at least partially based on user data received from a user.

22. The system of claim 21, wherein the user deduction information identifies one or more of child tax credit, mortgage interest, earned income credit, student load interest, dependent information, and charitable donations for the user.

23. The system of claim 21, wherein the user deduction information is first user deduction information, the method further comprising:
prior to acquiring second user deduction information from the user during the tax return preparation interview, displaying characteristics for the first user deduction information in the first section of the user interface to orient the user with a deduction section of the tax return preparation interview and to indicate to the user which of the first user deduction information has been identified by the electronic tax return preparation system as being relevant to the user.

24. The system of claim 23, further comprising:
in the second section of the user interface, acquiring the second user deduction information from the user, in response to receipt of an indication from the user that the first user deduction information is an incomplete representation of total user deduction information for the user; and
updating the first section of the user interface with the second user deduction information acquired from the user within the second section of the user interface to provide an updated status of the total user deduction information acquired by the electronic tax return preparation system for the user, to improve understandability by the user of the tax return preparation interview and to reduce the likelihood of abandonment of the tax return preparation interview by the user.

25. The system of claim 24, wherein acquiring the second user deduction includes providing, in the second section of the user interface, at least one of:
an expandable and self-explorable table of contents of tax topics associated with tax deductions and credits; and
a guided question and answer exploration through the tax topics associated with tax deductions and credits.

26. The system of claim 25, wherein the tax topics associated with the tax deductions and credits are ranked in order of relevance to the user, based on the first and second user income information and at least partially based on the user data, wherein providing the guided question and answer exploration through tax topics includes providing questions related with the tax topics associated with the tax deduction and credits in the order of relevance to the user.

27. The system of claim 15, wherein the user data includes one or more of:
a change in marital status;
a change in number of dependents;
a change of address; and
a death.

28. The system of claim 15, wherein user data includes one or more of:
a job change;
a change in salary;
a new dependent;
a change of address;
a purchase of a home;
a selling of a home;
receipt of unemployment;
educational expenses;
indication of having performed contract work; and
ownership of a business.
